(19) United States
(12) Patent Application Publication
(10) Pub. No.: US 2008/0265804 A1
(43) Pub. Date: Oct. 30, 2008

(54) Speed Control of a Variable Speed Motorized System

(75) Inventors: Wai-leung Ha, Pokfulam (HK); Kairy Kai Lei, Shen Zhen (CN)

Correspondence Address: BANNER & WITCOFF, LTD., TEN SOUTH WACKER DRIVE, SUITE 3000, CHICAGO, IL, 60606, US

(73) Assignee: Computime, Ltd., Wanchai (HK)

(21) Appl. No.: 11/740,540

(22) Filed: Apr. 26, 2007

(51) Int. Cl. H02P 25/00; G06F 19/00

(52) U.S. Cl. 318/11; 700/151

(57) ABSTRACT

The present invention provides apparatuses, computer media, and methods for controlling the speed and direction of a controlled device. An input device provides input information, which is converted into speed information and direction information. A controlled device, e.g., a variable speed motor, is then instructed to operate at a device speed and direction in accordance with the speed information and direction information. The remote device may include a circular input device through which a user draws strokes. The remote device instructs the controlled device to operate at a device speed and a direction in accordance with extracted characteristics of the entered stroke such as the speed of drawing the stroke and the direction of the stroke. The remote device then transmits a signal with speed and direction information to control the controlled device.

### FIELD OF THE INVENTION

The present invention relates generally to entering input data to control a controlled device. In particular, a user may enter a stroke through a circular device or perform a movement through a sliding device to control the speed and direction of the controlled device.

### BACKGROUND OF THE INVENTION

With the emerging variable speed motor control technology, many systems that were previously controlled by fixed speed motors can now be controlled by using variable speed motors. As a result, much better performance may be achieved by adjusting the speed of the motor to match the intended usage using different speed in the system. The usage of variable speed motors include a plethora of applications, including window blinds, garage doors, security gates, fans, and any systems related to flow control.

The number of controlled devices with variable speed motors is increasing. Moreover, users typically desire to remotely control the controlled devices. Thus, there is a real market need to facilitate controlling variable speed motors.

### SUMMARY OF THE INVENTION

The present invention provides apparatuses, computer media, and methods for controlling the speed and direction of a controlled device.

With one aspect of the invention, an input device provides input information. The input information is converted into speed information and direction information. A controlled device is then instructed to operate at a device speed and direction in accordance with the speed information and direction information.

With another aspect of the invention, a controlled device includes a variable speed motor. A remote device controls the speed and direction of the motor in accordance with input information.

With another aspect of the invention, a remote device has a circular input device through which a user draws strokes. The remote device instructs the controlled device to operate at a device speed and a direction in accordance with extracted characteristics of the entered stroke such as the speed of drawing the stroke and the direction of the stroke.

With another aspect of the invention, a remote device transmits a signal with speed information and direction information to control the controlled device.

With another aspect of the invention, a circular input device is partitioned into a plurality of regions. The locations of the start and end points are associated with identifications of the corresponding regions.

With another aspect of the invention, training information is obtained from the input device to configure a maximum speed value and a minimum speed value.

### BRIEF DESCRIPTION OF THE DRAWINGS

The foregoing summary of the invention, as well as the following detailed description of exemplary embodiments of the invention, is better understood when read in conjunction with the accompanying drawings, which are included by way of example, and not by way of limitation with regard to the claimed invention.

FIG. 1 shows an apparatus with a circular input device that controls a controlled device in accordance with an embodiment of the invention.

FIG. 2 shows an apparatus with a sliding input device that controls a controlled device in accordance with an embodiment of the invention.

FIG. 3 shows a circular input remote device controlling a variable speed motor in accordance with an embodiment of the invention.

FIG. 4 shows a sliding input remote device controlling a variable speed motor in accordance with an embodiment of the invention.

FIG. 5 shows a circular input device with exemplary strokes being entered in accordance with an embodiment of the invention.

FIG. 6 shows a flow diagram for training an apparatus to configure speed limits in accordance with an embodiment of the invention.

FIG. 7 shows a process for processing entered strokes to control a speed and direction of a controlled device in accordance with an embodiment of the invention.

FIG. 8 shows a process for determining a direction of an entered stroke in accordance with an embodiment of the invention.

### DETAILED DESCRIPTION OF INVENTION

The following is separated by subheadings for the benefit of the reader. The subheadings include: Terms, Architecture of Platform, Exemplary Scenario of Entering Strokes Through an Input Device, and Processing of Entered Strokes to Adjust Speed and Direction of a Controlled Device.

Terms

Stroke—a contiguous (uninterrupted) curve drawn on an input device, e.g., a circular input device. A start point is where the stroke begins and an endpoint is where the stroke ends.

Architecture of Platform

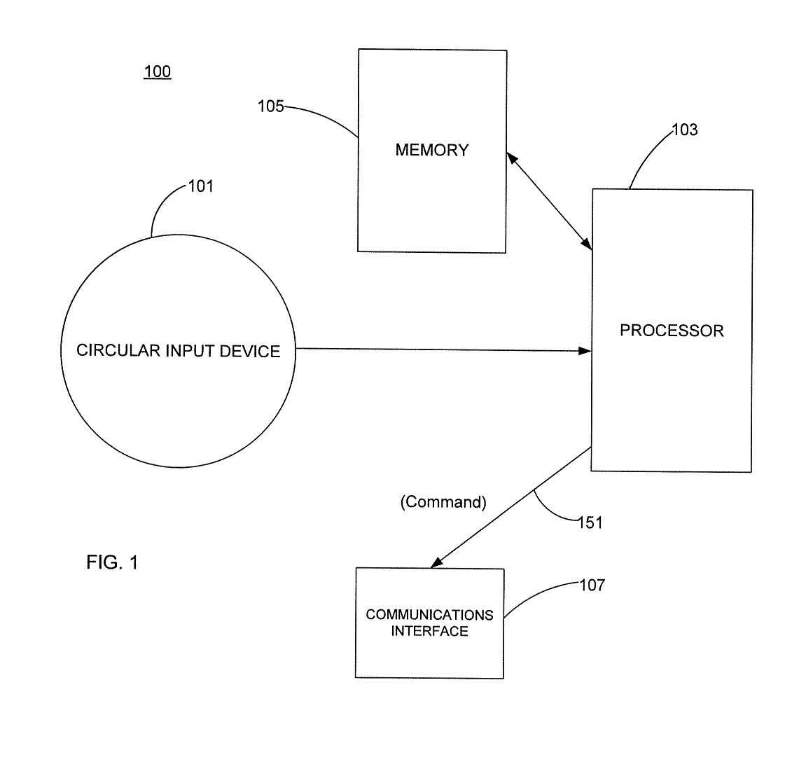

FIG. 1 shows apparatus 100 with circular input device 101 that controls a controlled device in accordance with an embodiment of the invention. Apparatus 100 can control both the speed and the direction of a variable speed motor (not shown in FIG. 1). Processor 103, by executing computer-executable instructions from memory 105, obtains speed information and direction information that are entered by the user through circular input device 101. As will be discussed, the speed information and the direction information are extracted from characteristics of an entered stroke. When processor 103 has extracted the speed and direction information, processor 103 sends a command message, which contains control information, to the controlled device (not shown in FIG. 1) over communications channel 151 through communications interface 107.

With embodiments of the invention, communications channel 151 may support different transmission media (including wireless, cable, and wire channels) and different frequency spectra (including radio and infra-red).

The speed and direction of the controlled device will vary depending on the speed and direction of the stroke/touch through circular input device 101 (e.g., in order to turn the speed up for a fan in a clockwise/counterclockwise direction or to adjust the speed of opening or closing window blinds in an up/down direction). The user can enter (draw) a stroke on the circular input device 101 with fast speed in a clockwise direction. The speed of the controlled device is adjusted in accordance with the speed of entering the stroke. Processor 103 determines the device speed by relating it to the entry speed of the user executing a movement (e.g., drawing a stroke or moving a sliding lever). For example, a linear relationship may be used:

device_speed=k*entry_speed EQ. 1

where device_speed is the operating speed of the controlled device, entry_speed is the speed at which an input movement is executed by the user, and k is a scaling factor.

The controlled direction of the controlled device corresponds to the direction of the stroke. Typically, entering the stroke in the clockwise/counterclockwise direction controls the controlled device in the clockwise/counterclockwise direction. For some controlled devices (e.g., window blinds), entering a stroke in a clockwise direction may correspond to opening the controlled device and entering a stroke in a counterclockwise direction may correspond to closing the controlled device. The corresponding speeds and directions of the controlled equipment may be preset to an ex-factory setting. As will be discussed, embodiments of the invention may support training apparatus 100 to configure a maximum speed limit and a minimum speed limit by inputting an entered stroke through circular input device 101 when apparatus 100 is in a training mode.

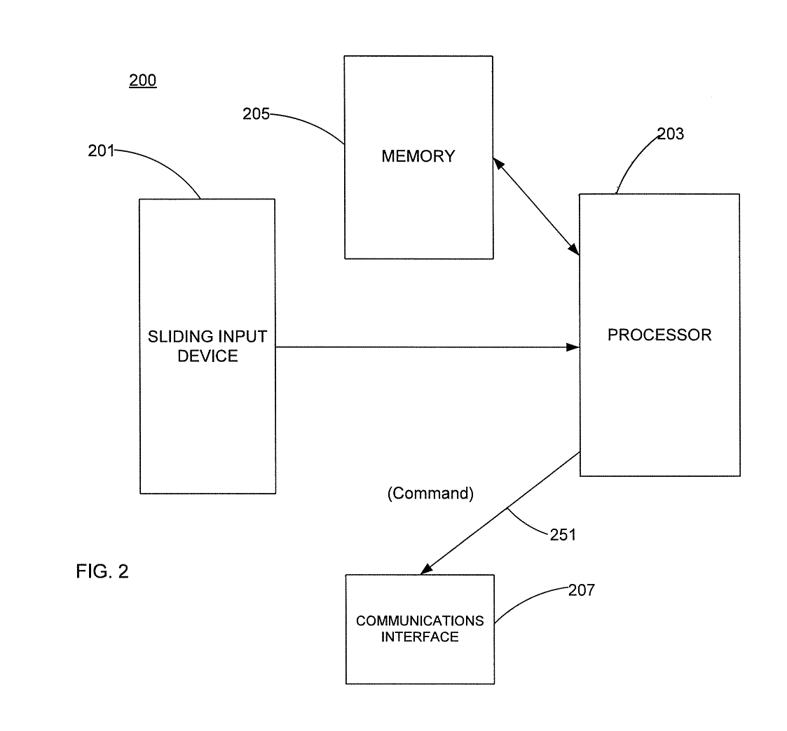

FIG. 2 shows apparatus 200 with a sliding input device 201 that controls a controlled device in accordance with an embodiment of the invention. Apparatus 200 can control both the speed and the direction of a variable speed motor (not shown in FIG. 2). Processor 203, by executing computer-executable instructions from memory 205, obtains speed information and direction information that are entered by the user through sliding input device 201. As will be discussed, the speed information and the direction information are extracted from characteristics of a movement executed by a user through sliding input device 201. When processor 203 has extracted the speed and direction information, processor 203 sends a command message, which contains control information, to the controlled device (not shown in FIG. 2) over communications channel 251 through communications interface 207.

The speed and direction of the controlled device will vary depending on the speed and direction of an executed movement through the sliding input device 201 (e.g., in order to turn the speed up for a fan in a clockwise/counterclockwise direction or to adjust the speed of opening or closing window blinds in an up/down direction). The user can execute a movement on sliding input device 201 with fast speed in an up direction (corresponding to a motor rotating in a clockwise direction) or in a down direction (corresponding to a motor rotating in a counterclockwise direction). The speed of the controlled device is adjusted in accordance with the speed of a user executing the movement. The controlled direction of the controlled device corresponds to the direction of the movement.

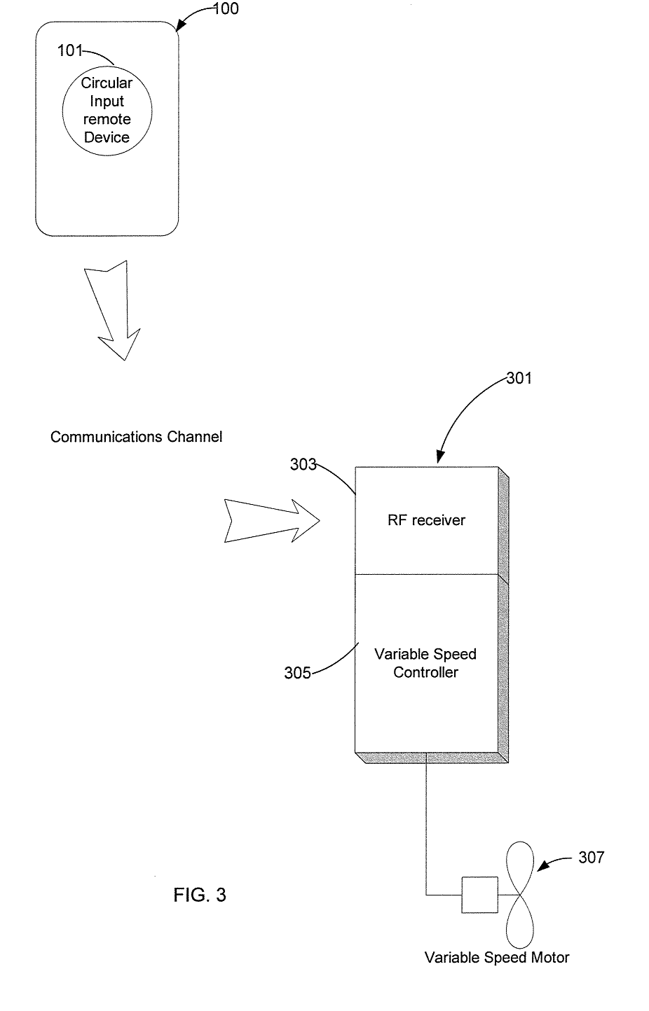

FIG. 3 shows remote device 100 (as shown in FIG. 1) controlling variable speed motor 307 in accordance with an embodiment of the invention. As discussed previously, remote device 100 converts input data from circular input device 101 into speed information and direction information for inclusion in a message that is transmitted to controlled device 301 over wireless communications channel 151. RF receiver 303 receives the message and extracts speed information and direction and instructs variable speed controller 305 to control variable speed motor 307 at a corresponding speed and direction.

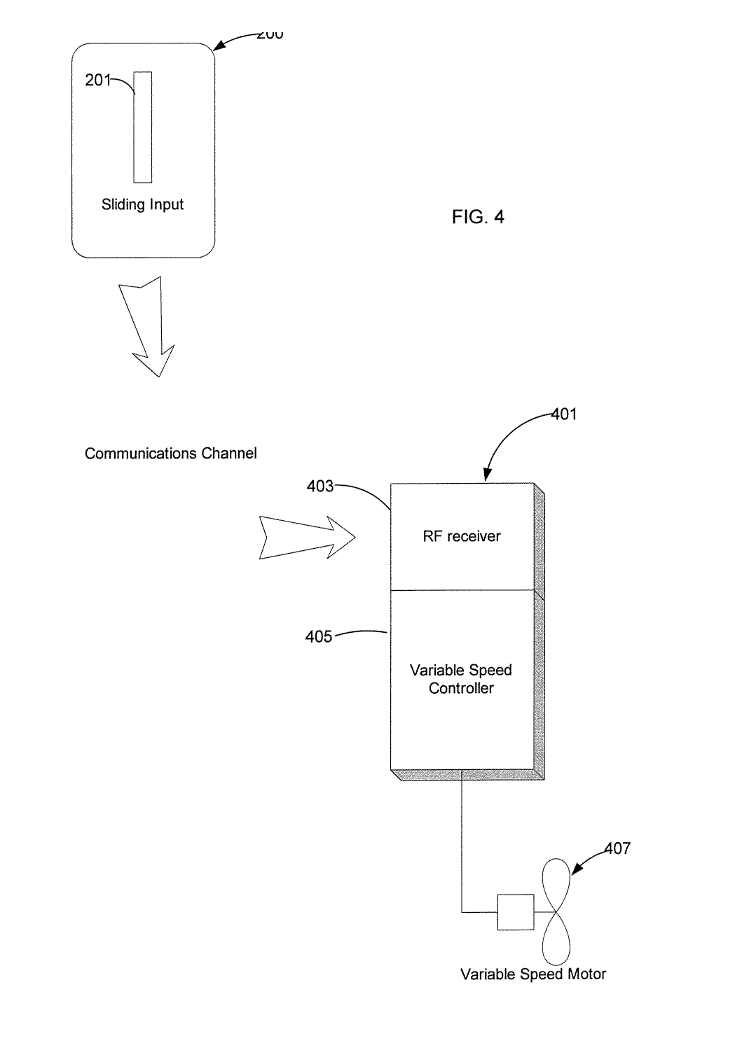

FIG. 4 shows sliding input remote device 200 (as shown in FIG. 2) controlling variable speed motor 407 in accordance with an embodiment of the invention. As discussed previously, remote device 200 converts input data from sliding input device 201 into speed information and direction information for inclusion in a message that is transmitted to controlled device 401 over wireless communications channel 251. RF receiver 403 receives the message and extracts speed information and direction and instructs variable speed controller 405 to control variable speed motor 407 at a corresponding speed and direction.

Exemplary Scenario of Entering Strokes Through an Input Device

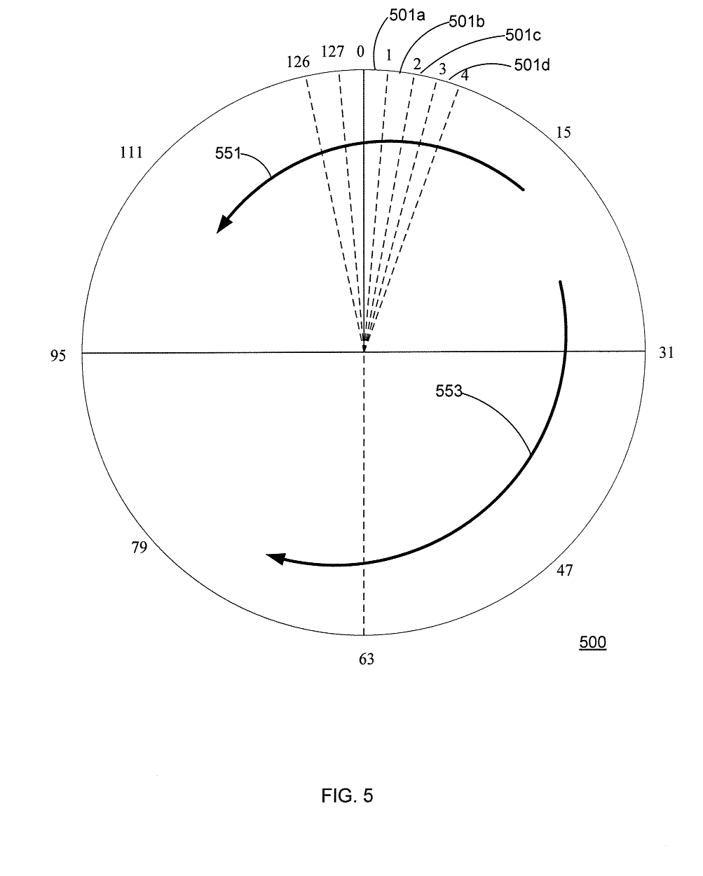

FIG. 5 shows circular input device 500 with exemplary strokes 551 and 553 being entered in accordance with an embodiment of the invention. Apparatus 100 extracts both speed information and direction information from each of the strokes. It should be noted that with prior art a controlling device typically increases the speed of a controlled device when the input device is turning clockwise and decreases the speed of the controlled device when the input device is turning counterclockwise. Similarly, a controlling device typically increases the speed of a controlled device when the input device is moving up and decreases the speed of the controlled device when the input device is turning down.

With the exemplary embodiment, circular input device 500 is partitioned into 128 radial regions (e.g., regions 501a-501d), each region being associated with a region identification. Each stroke has a start point and an end point. Stroke 551 has a start point location=15 and an end point location=111, and stroke 553 has a start point location=25 and an end point location=69. The direction of strokes 551 and 553 are counterclockwise and clockwise, respectively.

As will be discussed, the speed information is determined by the speed of entering (drawing) a stroke on circular input device 500. For example, a difference between the start point location and the end point location divided by the time for entering the stroke approximates the speed information.

Processing of Entered Strokes to Adjust Speed and Direction of a Controlled Device

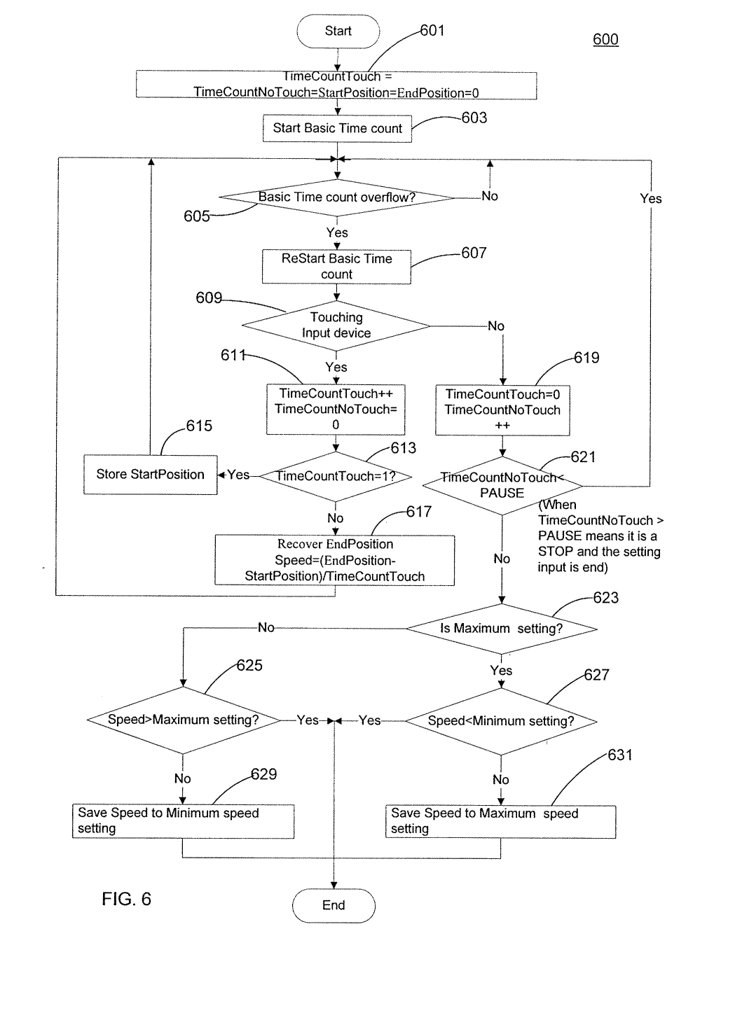

FIG. 6 shows flow diagram 600 for training an apparatus to configure speed limits in accordance with an embodiment of the invention. A user scenario may entail a user to configure the remote control device to operate in the training mode, e.g., by entering a stroke or pressing a button on the remote control device.

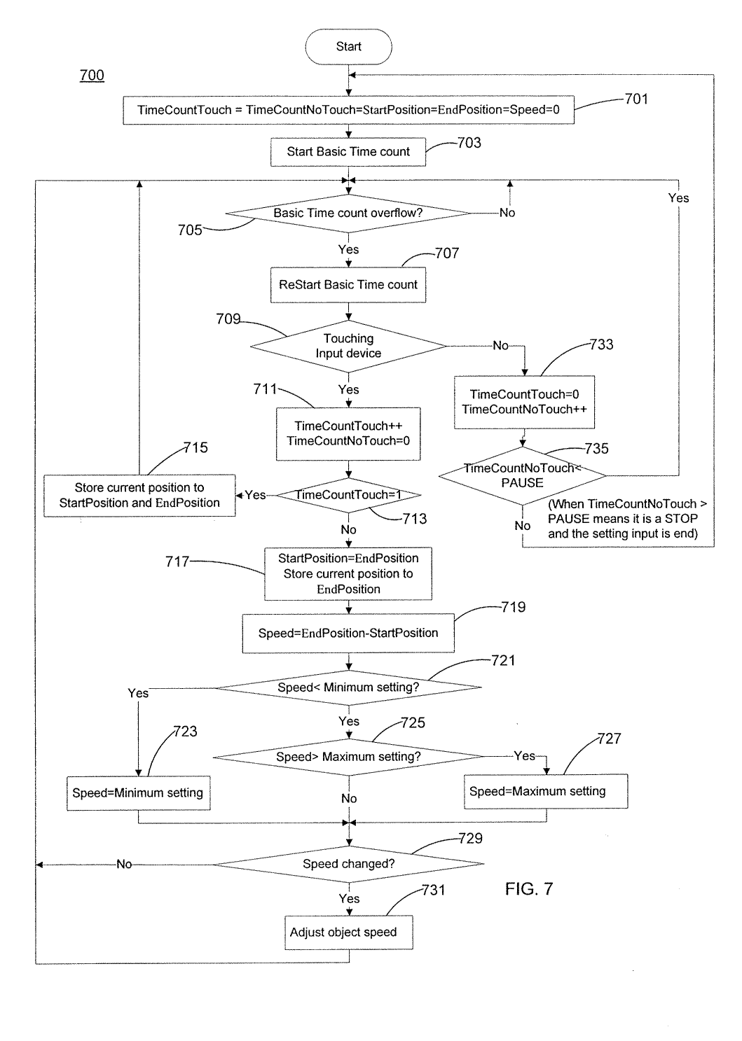

Counters are initialized in steps 601 and 603. (Basic time is a timer for the software to scan the touch interface periodically. Start Basic time count denotes that the timer starts counting.) If basic_time_count overflows, as determined by step 605, the basic_time_count counter is reset in step 607. Step 609 then determines whether the user is entering a stroke. If so, steps 611-617 are executed to determine the speed of entering the stroke in step 617 (designated as Speed). If the user has completed drawing the stroke, as determined by steps 619 and 621, steps 623-631 are executed to set the minimum speed setting and the maximum speed setting, which are subsequently used in flow diagram 700 as shown in FIG. 7. If the training mode is to set maximum speed, the setting value must be more than the minimum setting. Setting the minimum speed is another training mode, but the corresponding process is similar as flow diagram 600.

FIG. 7 shows process 700 for processing entered strokes to control a speed and direction of a controlled device in accordance with an embodiment of the invention. Counters are initialized in steps 701 and 703. If basic_time_count overflows, as determined by step 705, the basic_time_count counter is reset in step 707. Step 709 then determines whether the user is entering a stroke. If so, steps 711-715 update the start point location and the end point location as the stroke is being drawn by the user. If the user has completed entering the stroke, as determined by steps 709, 733, and 735, then steps 717 and 719 determine the speed of entering the stroke. Basic time is the time interval used to determine the speed of entering a stroke. With embodiments of the invention, the linear expression shown in EQ. 1 is used to determine the motor speed from the speed of entering (drawing) a stroke. Since the motor speed limitation is preset in the software, after the user has set the maximum setting and minimum setting during the training mode, the scaling factor k can be calculated by:

k=(device_speed_max-device_speed_min)/(entry_speed_max-entry_speed_min EQ. 2

Steps 721-727 compare the speed of the motor (corresponding to the speed of drawing the stroke) with maximum and minimum limits of the motor speed. It the requested motor speed exceeds the motor speed limits, the determined motor speed is limited.

Step 729 determines if the requested motor speed has changed since the last update. If so, remote device 100 or 200 sends a message to controlled device 301 or 401 with speed information and direction information as shown in FIGS. 3 and 4. However, with embodiments of the invention, no message is sent if the requested motor speed and direction remains unchanged. However, with embodiments of the invention, a message may be send for every update, whether or not the motor speed changes.

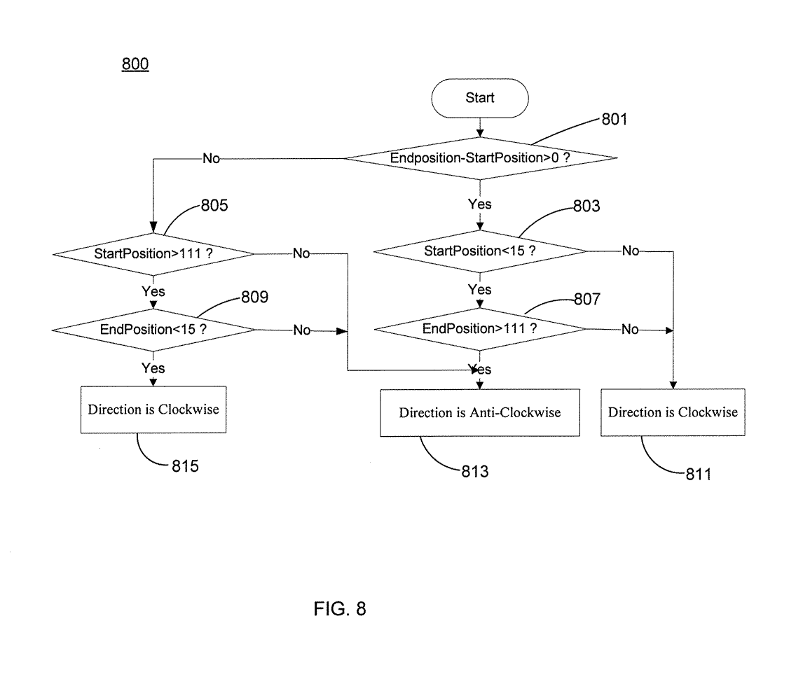

FIG. 8 shows process 800 for determining a direction of an entered stroke in accordance with an embodiment of the invention. The exemplary embodiment shown in process 800 refers to the section number assignments that are shown in FIG. 5. Steps 801-809 analyze the locations (positions) of the start point and end point of the entered stroke. The direction of the stroke is determined in steps 811-815, where the direction may be either clockwise or anti-clockwise (counterclockwise).

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for controlling a controlled device, comprising:
(a) obtaining input information from an input device;
(b) converting the input information into speed information and direction information; and
(c) instructing the controlled device to operate at a device speed and device direction in accordance with the speed information and the direction information.

2. The method of claim 1, the controlled device comprising a variable speed motor.

3. The method of claim 1, the input information being descriptive of a stroke entered by a user through a circular input device.

4. The method of claim 3, (b) comprising:
(b)(i) determining an entry speed of entering the stroke by a user; and
(b)(ii) determining an entry direction of the stroke.

5. The method of claim 1, (c) comprising:
(c)(i) transmitting a signal over a communications channel, the signal containing data that is representative of the speed information and the direction information.

6. The method of claim 1, the input information being descriptive of a motion through a sliding input device.

7. The method of claim 1, further comprising:
(d) obtaining training information from the input device to establish a maximum speed value and a minimum speed value.

8. The method of claim 4, (b)(i) comprising:
(b)(i)(1) obtaining a start point location and an end point location of the stroke; and
(b)(i)(2) determining the speed information from the start point location and the end point location.

9. The method of claim 1, (c) comprising:
(c)(i) instructing the controlled device only when the speed information changes.

10. The method of claim 8, (b)(ii) comprising:
(b)(ii)(1) determining the direction information from the start point location and the end point location of the stroke.

11. The method of claim 2, (b) comprising:
(b)(i) determining an entry speed of an input motion through the input device; and
(b)(ii) estimating the speed information from a linear relationship, the linear relationship relating a motor speed and the entry speed.

12. The method of claim 1, the device direction being selected from the group consisting of a clockwise direction and a counterclockwise direction.

13. The method of claim 1, the device direction being selected from the group consisting of an up direction and a down direction.

14. The method of claim 3, further comprising:
(d) partitioning the circular input device into a plurality of regions, each region being associated with a region identification; and
(e) associating a start point location and an end point location of the stroke with corresponding region identifications.

15. An apparatus for controlling a variable speed motor, comprising:
a circular input device providing input information for an entered stroke; and
a processor converting the input information into speed information and direction information and instructing the variable speed motor to operate at a motor speed and motor direction in accordance with the speed information and the direction information.

16. The apparatus of claim 15, the processor determining the speed information from an entry speed of entering the stroke by the user.

17. The apparatus of claim 16, the processor obtaining a start point location and an end point location of the stroke and determining the speed information from the start point location and the end point location.

18. The apparatus of claim 15, the processor determining the direction information from an entry direction of the stroke.

19. The apparatus of claim 15, the processor obtaining training information from the circular input device to establish a maximum speed value and a minimum speed value.

20. The apparatus of claim 15, further comprising:
a communications interface transmitting a signal over a communications channel, the signal containing data that is representative of the speed information and the direction information.

21. A computer-readable medium having computer-executable instructions to perform:
(a) obtaining input information from a circular input device;
(b) converting the input information into speed information and direction information; and
(c) instructing an adjustable speed motor to operate at a motor speed and motor direction in accordance with the speed information and the direction information.

22. The computer-readable medium of claim 21, further configured to perform:
(b)(i) determining an entry speed of entering the stroke by the user; and
(b)(ii) determining an entry direction of the stroke.

23. The computer-readable medium of claim 22, further configured to perform:
(b)(i)(1) obtaining a start point location and an end point location of the stroke;
(b)(i)(2) determining the speed information from the start point location and the end point location; and
(b)(ii)(1) determining the direction information from the start point location and the end point location of the stroke.

24. The computer-readable medium of claim 21, further configured to perform:
(d) obtaining training information from the input device to establish a maximum speed value and a minimum speed value.
